(19) United States
(12) Patent Application Publication
(10) Pub. No.: US 2025/0071299 A1
(43) Pub. Date: Feb. 27, 2025

(54) MEDIA COMPRESSION AND PROCESSING FOR MACHINE-LEARNING-BASED QUALITY METRICS

(71) Applicant: GOOGLE LLC, Mountain View, CA (US)

(72) Inventors: Yao-Chung Lin, Sunnyvale, CA (US); Jingning Han, Santa Clara, CA (US); Yilin Wang, Sunnyvale, CA (US); Yeping Su, Palo Alto, CA (US)

(21) Appl. No.: 18/455,298

(22) Filed: Aug. 24, 2023

(51) Int. Cl. H04N 19/196; H04N 19/105; H04N 19/176; H04N 19/80

(52) U.S. Cl. CPC H04N 19/196; H04N 19/105; H04N 19/176; H04N 19/80

(57) ABSTRACT

Encoding using media compression and processing for machine-learning-based quality metrics includes generating encoded frame data by encoding a current frame from an input video using a neural-network-based video quality model, which includes identifying optimal encoding parameters for encoding a current block, wherein the optimal encoding parameters minimize a rate-distortion optimization cost function, which includes using a gradient value for the current block obtained from a neural-network-based video quality model generated gradient map obtained from the neural-network-based video quality model for the current frame, obtaining a restoration filtered reconstructed frame by restoration filtering a reconstructed frame, obtained by decoding the encoded frame data, using the neural-network-based video quality model generated gradient map obtained for the reconstructed frame.

### BACKGROUND

Digital images and video can be used, for example, on the internet, for remote business meetings via video conferencing, high-definition video entertainment, video advertisements, or sharing of user-generated content. Due to the large amount of data involved in transferring and processing image and video data, high-performance compression may be advantageous for transmission and storage. Accordingly, it would be advantageous to provide high-resolution image and video transmitted over communications channels having limited bandwidth.

### SUMMARY

This application relates to encoding and decoding of image data, video stream data, or both for transmission, storage, or both. Disclosed herein are aspects of systems, methods, and apparatuses for encoding and decoding using media compression and processing for machine-learning-based quality metrics.

Variations in these and other aspects will be described in additional detail hereafter.

An aspect is a method for encoding using media compression and processing for machine-learning-based quality metrics. Encoding using media compression and processing for machine-learning-based quality metrics includes generating encoded frame data by encoding a current frame from an input video, wherein encoding the current frame includes using a neural-network-based video quality model and outputting the encoded frame data. Encoding the current frame using the neural-network-based video quality model may include obtaining a neural-network-based video quality model generated gradient map generated for the current frame by the neural-network-based video quality model, obtaining a current block from the current frame, identifying optimal encoding parameters for encoding the current block from a plurality of available encoding parameters, wherein the optimal encoding parameters minimizes a rate-distortion optimization cost function relative to the plurality of available encoding parameters, wherein minimizing the rate-distortion optimization cost function includes using a gradient value for the current block obtained from the neural-network-based video quality model generated gradient map, obtaining encoded block data by encoding the current block using the optimal encoding parameters, and including the encoded block data in the encoded frame data. Encoding the current frame using the neural-network-based video quality model may include obtaining a reconstructed frame by decoding the encoded frame data, obtaining a neural-network-based video quality model generated gradient map generated for the reconstructed frame from the neural-network-based video quality model, obtaining a restoration filtered reconstructed frame by restoration filtering the reconstructed frame using the neural-network-based video quality model generated gradient map, and storing the restoration filtered reconstructed frame for use as a reference frame for encoding another frame.

An aspect is an apparatus for encoding using media compression and processing for machine-learning-based quality metrics. The apparatus includes a non-transitory computer readable medium and a processor. The processor is configured to execute instructions stored on the non-transitory computer readable medium to generate encoded frame data, wherein, to generate the encoded frame data the processor executes the instructions to encode a current frame from an input video, wherein to encode the current frame the processor executes the instructions to use a neural-network-based video quality model and output the encoded frame data. To use the neural-network-based video quality model the processor may execute the instructions to obtain a neural-network-based video quality model generated gradient map generated for the current frame by the neural-network-based video quality model, obtain a current block from the current frame, identify optimal encoding parameters for encoding the current block from a plurality of available encoding parameters, wherein the optimal encoding parameters minimizes a rate-distortion optimization cost function relative to the plurality of available encoding parameters, wherein to maximize the rate-distortion optimization cost function the processor executes the instructions to use a gradient value for the current block obtained from the neural-network-based video quality model generated gradient map, obtain encoded block data, wherein, to obtain the encoded block data the processor executes the instructions to encode the current block using the optimal encoding parameters, and include the encoded block data in the encoded frame data. To use the neural-network-based video quality model the processor may execute the instructions to obtain a reconstructed frame, wherein, to obtain the reconstructed frame the processor executes the instructions to decode the encoded frame data, obtain a neural-network-based video quality model generated gradient map generated for the reconstructed frame from the neural-network-based video quality model, obtain a restoration filtered reconstructed frame, wherein, to obtain the restoration filtered reconstructed frame the processor executes the instructions to restoration filter the reconstructed frame using the neural-network-based video quality model generated gradient map, and store the restoration filtered reconstructed frame for use as a reference frame for encoding another frame.

An aspect is a method for decoding using media compression and processing for machine-learning-based quality metrics. Decoding using media compression and processing for machine-learning-based quality metrics includes obtaining an encoded bitstream, obtaining encoded frame data from the encoded bitstream, obtaining a reconstructed frame by decoding the encoded frame data, obtaining restoration filtered reconstructed frame data by obtaining, from a neural-network-based video quality model, a neural-network-based video quality model generated gradient map generated for the reconstructed frame, and generating restoration filtered reconstructed frame data by restoration filtering the reconstructed frame using the neural-network-based video quality model generated gradient map, and storing the restoration filtered reconstructed frame for use as a reference frame for encoding another frame.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram of a representation of a portion of a frame in accordance with implementations of this disclosure.

FIG. 7 is a flow diagram of an example of encoding using media compression and processing for machine-learning-based quality metrics in accordance with implementations of this disclosure.

FIG. 8 is a flow diagram of an example of decoding using media compression and processing for machine-learning-based quality metrics in accordance with implementations of this disclosure.

### DETAILED DESCRIPTION

Media, such as audio media, image media, video media, and the like, is compressed to reduce resource utilization, such as storage utilization, transmission bandwidth utilization, or both. Media compression may be lossless or lossy. In lossy media compression, some information may be removed, or lost, relative to input or source media, to obtain compressed, or encoded, media, that has reduced resource utilization, such as storage utilization, transmission bandwidth utilization, or both, relative to the input or source media. Reconstructed media obtained by decoding lossy compressed, or encoded, media, has reduced quality, or accuracy, relative to the input or source media and corresponding to the information removed, or lost.

Image and video compression schemes may include breaking an image, or frame, into smaller portions, such as blocks, and generating an output bitstream using techniques to minimize the bandwidth utilization of the information included for each block in the output. In some implementations, the information included for each block in the output may be limited by reducing spatial redundancy, reducing temporal redundancy, or a combination thereof. For example, temporal or spatial redundancies may be reduced by predicting a frame, or a portion thereof, based on information available to both the encoder and decoder, and including information representing a difference, or residual, between the predicted frame and the original frame in the encoded bitstream. The residual information may be further compressed by transforming the residual information into transform coefficients (e.g., energy compaction), quantizing the transform coefficients, and entropy coding the quantized transform coefficients. Other coding information, such as motion information, may be included in the encoded bitstream, which may include transmitting differential information based on predictions of the encoding information, which may be entropy coded to further reduce the corresponding bandwidth utilization. An encoded bitstream can be decoded to reconstruct the blocks and the source images from the limited information. In some implementations, the accuracy, efficiency, or both, of coding a block using either inter-prediction or intra-prediction may be limited.

In some implementations, media may be encoded, with lossy compression, in accordance with one or more defined, or allocated, constraints, such as a bitrate constraint, an encoded data size, or file size, constraint, or a combination thereof, wherein the encoder determines one or more encoding, or compression, parameters, such as an encoding mode, or one or more other aspects of encoding, or compression, such as via rate allocation, rate control, encoding mode determination, or a combination thereof, to minimize the reduction in quality (maximize reconstructed quality). The reduction in quality may be determined based on one or more distortion metrics, indicating distortion between the reconstructed media and the input, or source, media, such as mean squared error, or one or more derivatives thereof, such as peak signal-to-noise ratio (PSNR), which may be weakly correlated to human perceived quality.

In some implementations, one or more distortion, quality, or both, metrics that have relatively high correlation, relative to weakly correlated metrics, to human perceived quality may be used. For example, structural similarity (SSIM) includes using structural changes by using the first two orders of pixel statistics, such as mean and covariances, in blocks. In another example, video multi-method assessment fusion (VMAF) uses a combination of fidelity loss, detail loss, and temporal differences to predict perceived quality loss. Such metrics have relatively high correlation, relative to weakly correlated metrics, to human perceived quality as measured by mean opinion scores (MOS). Some metrics (advanced quality metrics) having relatively high mean opinion scores, use an artificial intelligence, or machine learning, model, such as an artificial neural network, such as a universal video quality (UVQ) model. Some advanced quality, or advanced distortion and quality, metrics, which are per-frame metrics, may be impracticable for use in per-block video encoder optimization.

In some implementations, some aspects, or base features, of one or more advanced quality metrics, such as visual information fidelity, detail loss metrics, and mean co-located pixel difference, are implemented for media, such as video, encoder optimization.

For example, pixel variance may be used as a delegation of structural similarity and a sum of squared differences (SSD) may be modeled to video multi-method assessment fusion for simplifying optimization.

Many quality metrics, such as signal-to-noise ratio and video multi-method assessment fusion, are reference-based, such as based on differences between source, input, or reference media and corresponding reconstructed media. For some media, reference-based quality metrics are weakly correlated to human perception.

Block-based hybrid video coding techniques, or codecs, to improve coding efficiency, may implement encoding and decoding using media compression and processing for machine-learning-based quality metrics.

The encoding and decoding using media compression and processing for machine-learning-based quality metrics described herein improves on media coding techniques, or codecs, by optimizing rate-distortion optimization for encoding parameter determination, such as encoding mode decisions, in accordance with a gradient map obtained, from a machine learning media quality model, for the input media, improving reconstructed media quality by using a restoration filter in accordance with a gradient map obtained, from the machine learning media quality model, for the reconstructed media, or both.

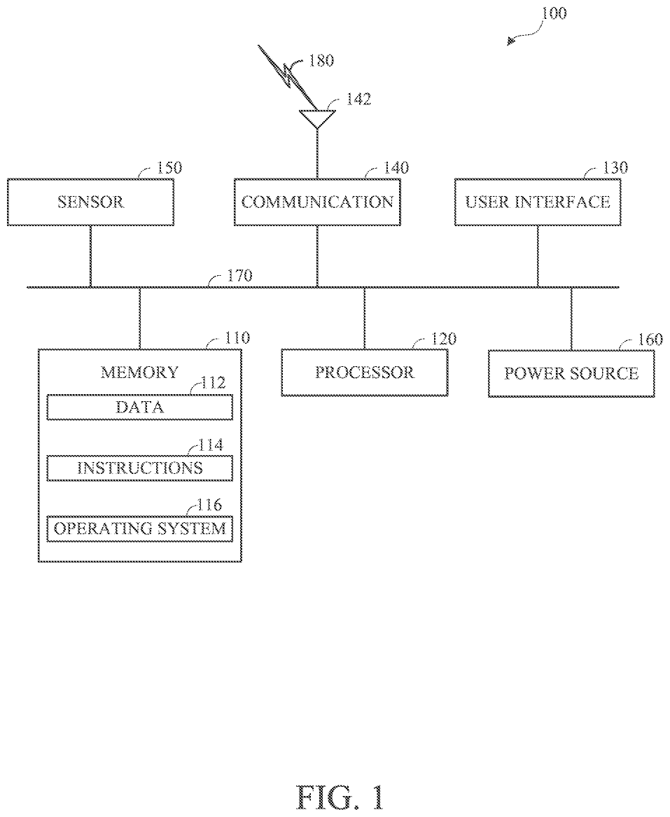

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input audio data, encoded audio data, decoded audio data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, 100 the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

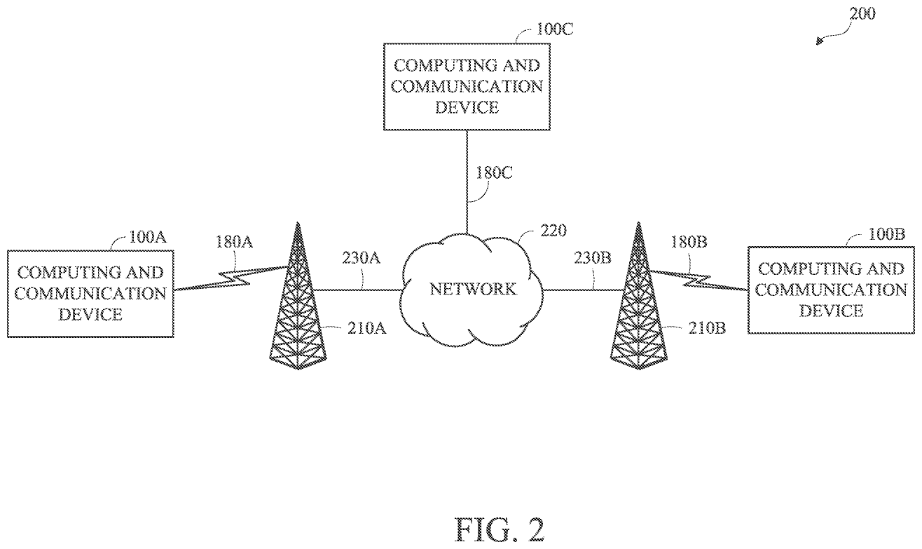

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof audio data and one or both of the computing and communication device 100A and the computing and communication device 100B may receive, decode, process, store, present, or a combination thereof the audio data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VOIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

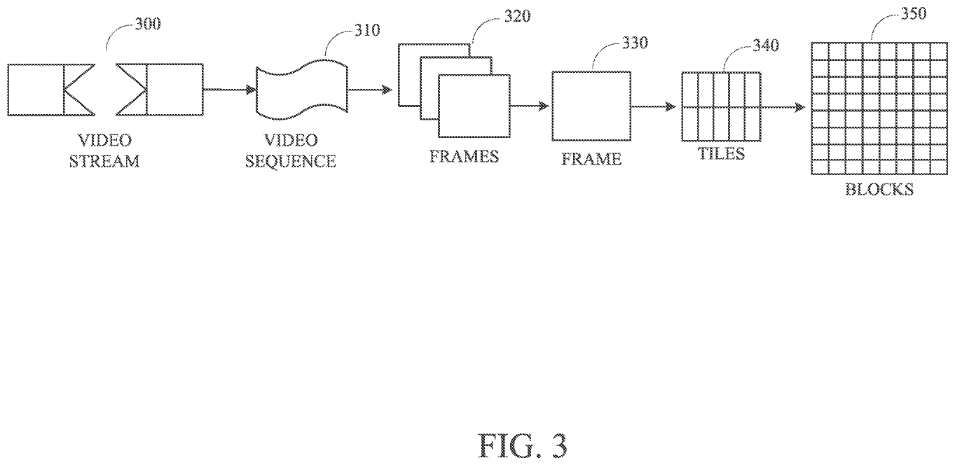

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

Each frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. Each of the tiles 340 may be a rectangular region of the frame that can be coded independently. Each of the tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

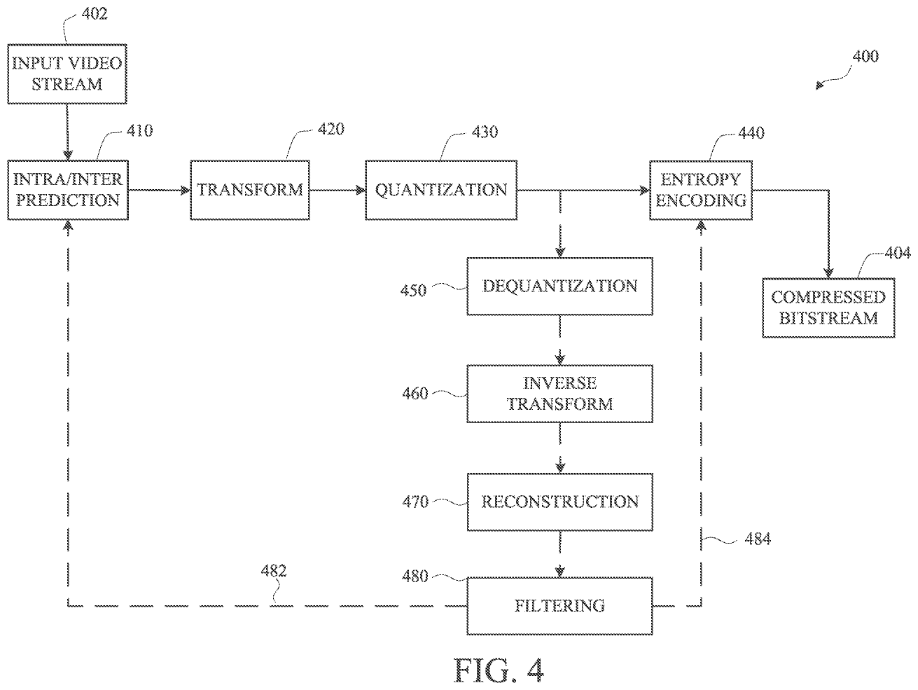

FIG. 4 is a block diagram of an encoder 400 in accordance with implementations of this disclosure. Encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference portion of the reference frame.

The intra/inter prediction unit 410 may subtract the prediction block from the current block (raw block) to produce a residual block. The transform unit 420 may perform a block-based transform, which may include transforming the residual block into transform coefficients in, for example, the frequency domain. Examples of block-based transforms include the Karhunen-Loève Transform (KLT), the Discrete Cosine Transform (DCT), the Singular Value Decomposition Transform (SVD), and the Asymmetric Discrete Sine Transform (ADST). In an example, the DCT may include transforming a block into the frequency domain. The DCT may include using transform coefficient values based on spatial frequency, with the lowest frequency (i.e., DC) coefficient at the top-left of the matrix and the highest frequency coefficient at the bottom-right of the matrix.

The quantization unit 430 may convert the transform coefficients into discrete quantum values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the block, which may include the type of prediction used, motion vectors, and quantizer values, can be output to the compressed bitstream 404. The compressed bitstream 404 can be formatted using various techniques, such as run-length encoding (RLE) and zero-run coding.

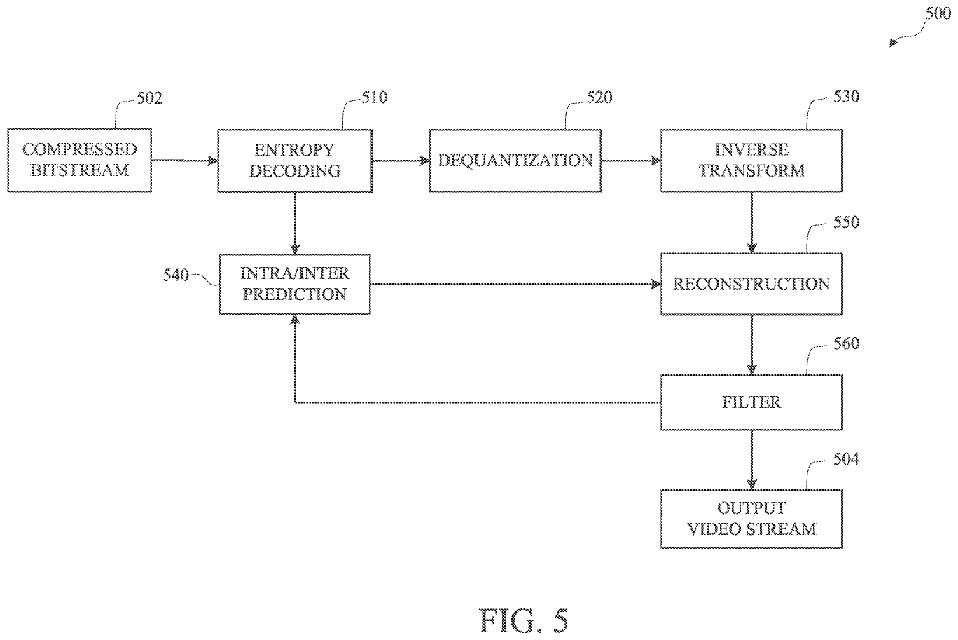

The reconstruction path can be used to maintain reference frame synchronization between the encoder 400 and a corresponding decoder, such as the decoder 500 shown in FIG. 5. The reconstruction path may be similar to the decoding process discussed below and may include decoding the encoded frame, or a portion thereof, which may include decoding an encoded block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. The reconstructed block may be stored or otherwise made accessible as a reconstructed block, which may be a portion of a reference frame, for encoding another portion of the current frame, another frame, or both, as indicated by the broken line at 482. Coding information, such as deblocking threshold index values, for the frame may be encoded, included in the compressed bitstream 404, or both, as indicated by the broken line at 484.

Other variations of the encoder 400 can be used to encode the compressed bitstream 404. For example, a non-transform-based encoder 400 can quantize the residual block directly without the transform unit 420. In some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

Other variations of the decoder 500 can be used to decode the compressed bitstream 502. For example, the decoder 500 can produce the output video stream 504 without the deblocking filtering unit 570.

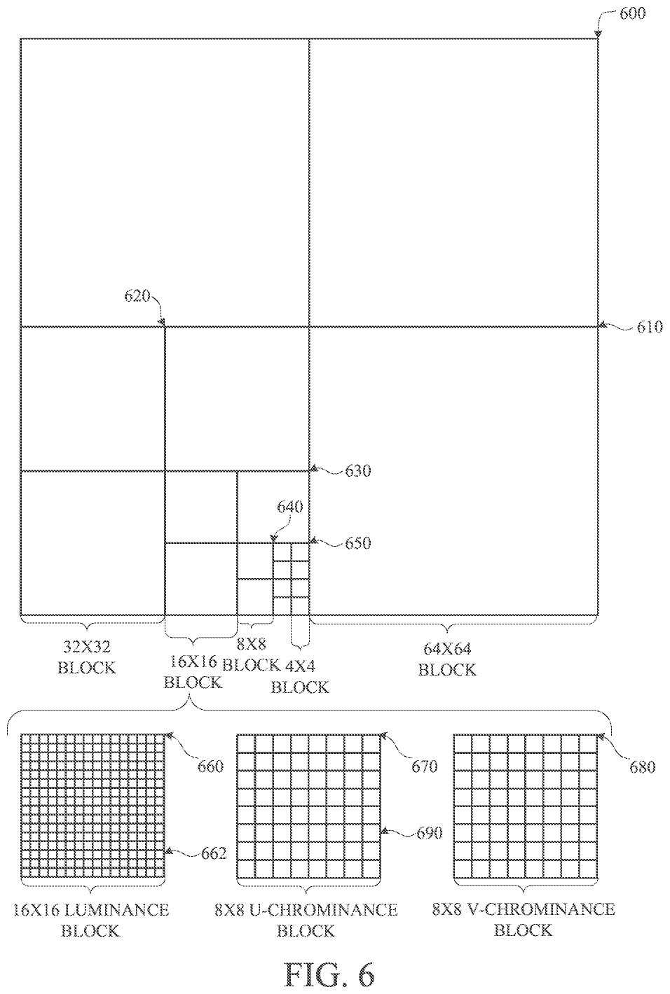

FIG. 6 is a block diagram of a representation of a portion 600 of a frame, such as the frame 330 shown in FIG. 3, in accordance with implementations of this disclosure. As shown, the portion 600 of the frame includes four 64×64 blocks 610, in two rows and two columns in a matrix or Cartesian plane. In some implementations, a 64×64 block may be a maximum coding unit, N=64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used. For example, 32×64 blocks, 64×32 blocks, 16×32 blocks, 32×16 blocks, or any other size blocks may be used. In some implementations, N×2N blocks, 2N×N blocks, or a combination thereof may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame and using a relatively small amount of information to represent each corresponding chrominance component for the portion of the frame. For example, a portion of a frame may be represented by a high-resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different spatial location and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a portion of a reference frame that corresponds to a current block or pixel of a current frame. For example, a reference frame, or a portion of a reference frame, which may be stored in memory, may be searched to identify a portion for generating a prediction to use for encoding a current block or pixel of the current frame with maximal efficiency. For example, the search may identify a portion of the reference frame for which the difference in pixel values between the current block and a prediction block generated based on the portion of the reference frame is minimized and may be referred to as motion searching. In some implementations, the portion of the reference frame searched may be limited. For example, the portion of the reference frame searched, which may be referred to as the search area, may include a limited number of rows of the reference frame. In an example, identifying the portion of the reference frame for generating a prediction may include calculating a cost function, such as a sum of absolute differences (SAD), between the pixels of portions of the search area and the pixels of the current block.

In some implementations, the spatial difference between the location of the portion of the reference frame for generating a prediction in the reference frame and the current block in the current frame may be represented as a motion vector. The difference in pixel values between the prediction block and the current block may be referred to as differential data, residual data, a prediction error, or as a residual block. In some implementations, generating motion vectors may be referred to as motion estimation, and a pixel of a current block may be indicated based on location using Cartesian coordinates as f_{x,y}. Similarly, a pixel of the search area of the reference frame may be indicated based on location using Cartesian coordinates as r_{x,y}. A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two-dimensional data structure such as a matrix as shown, or in a one-dimensional data structure, such as a vector array. In an implementation, a representation of the frame, such as a two-dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block-based coding efficiency may be improved by partitioning input blocks into one or more prediction partitions, which may be rectangular, including square, partitions for prediction coding. In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620 the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8 prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block-based coding efficiency may be improved by partitioning a current residual block into one or more transform partitions, which may be rectangular, including square, partitions for transform coding. In some implementations, video coding, such as video coding using transform partitioning, may include selecting a uniform transform partitioning scheme. For example, a current residual block, such as block 610, may be a 64×64 block and may be transformed without partitioning using a 64×64 transform.

Although not expressly shown in FIG. 6, a residual block may be transform partitioned using a uniform transform partitioning scheme. For example, a 64×64 residual block may be transform partitioned using a uniform transform partitioning scheme including four 32×32 transform blocks, using a uniform transform partitioning scheme including sixteen 16×16 transform blocks, using a uniform transform partitioning scheme including sixty-four 8×8 transform blocks, or using a uniform transform partitioning scheme including 256 4×4 transform blocks.

In some implementations, video coding, such as video coding using transform partitioning, may include identifying multiple transform block sizes for a residual block using multiform transform partition coding. In some implementations, multiform transform partition coding may include recursively determining whether to transform a current block using a current block size transform or by partitioning the current block and multiform transform partition coding each partition. For example, the bottom left block 610 shown in FIG. 6 may be a 64×64 residual block, and multiform transform partition coding may include determining whether to code the current 64×64 residual block using a 64×64 transform or to code the 64×64 residual block by partitioning the 64×64 residual block into partitions, such as four 32×32 blocks 620, and multiform transform partition coding each partition. In some implementations, determining whether to transform partition the current block may be based on comparing a cost for encoding the current block using a current block size transform to a sum of costs for encoding each partition using partition size transforms.

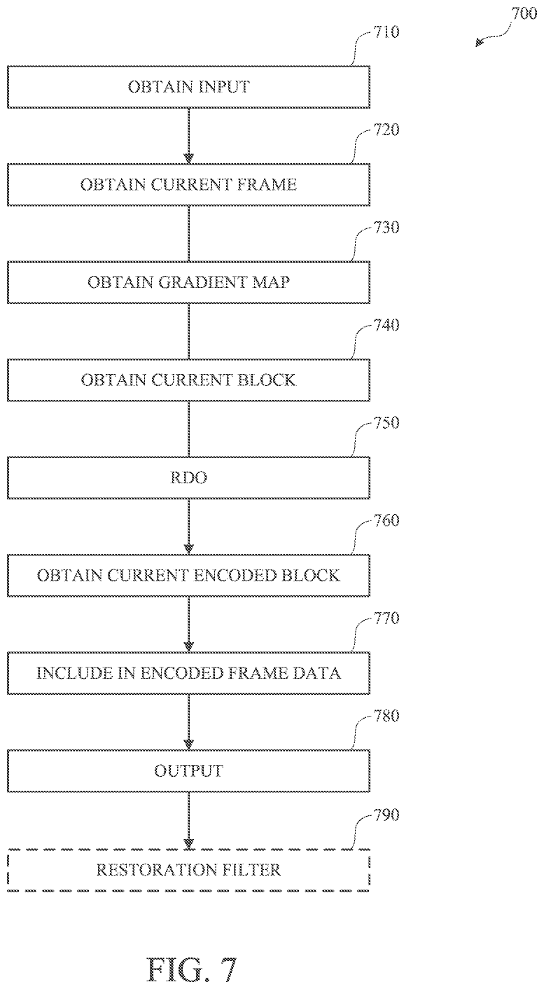

FIG. 7 is a flow diagram of an example of encoding using media compression and processing for machine-learning-based quality metrics 700 in accordance with implementations of this disclosure. Encoding using media compression and processing for machine-learning-based quality metrics 700 may be implemented by an encoder, such as the encoder 400 shown in FIG. 4.

Encoding using media compression and processing for machine-learning-based quality metrics 700 includes encoding an input video steam, such as the input video stream 402 shown in FIG. 4, or one or more portions thereof, to generate an encoded (compressed) output bitstream, such as the encoded (compressed) bitstream 404 shown in FIG. 4.

Encoding using media compression and processing for machine-learning-based quality metrics 700 includes obtaining an input video (at 710), obtaining a current frame (at 720), obtaining a gradient map for the current frame (at 730), obtaining a current block from the current frame (at 740), rate-distortion optimization (at 750), obtaining current encoded block data (at 760), including the encoded block data in the encoded frame data (at 770), output (at 780), and restoration filtering (at 790). Encoding using media compression and processing for machine-learning-based quality metrics 700 may include other elements of encoding not expressly shown in FIG. 7.

In block-based hybrid video coding, to reduce, or minimize, the resource utilization, such as bandwidth utilization, for signaling, storing, or both, compressed, or encoded, video data, redundant data, such as spatially redundant data, temporally redundant data, or both, is omitted or excluded from the compressed, or encoded, data. The amount, such as the number, count, or cardinality, of bits, of encoded data for a portion of a video, such as a sequence of frames, a frame, or a block, is the bitrate, or rate (R), for encoding the respective portion. Differences between a reconstructed portion of the encoded, or compressed, video and the input, or source, video portion may be used as a metric, or measure, of distortion (D) caused by the coding process, which corresponds to quality loss with respect to the reconstructed video. Optimal video coding minimizes distortion (D), in accordance with rate (R) limitations or targets. A combination of rate (R) and distortion (D) may be used as a metric, or measure, (cost) of encoding optimization.

To maximize encoding optimization, such as to minimize distortion (D) in accordance with rate (R) limitations or targets, the encoder performs rate-distortion optimization (RDO) for a portion, such as a block, of a video or frame, wherein the encoder identifies, or determines, encoding parameters from among candidate encoding parameters that maximize encoding optimization. For example, rate-distortion optimization may include determining prediction block, or subblock, sizes, transform block, or subblock, sizes, or both. In another example, rate-distortion optimization may include a mode decision that includes determining, identifying, or selecting, a prediction mode, such as an intra prediction mode or an inter prediction mode, for encoding a portion, such as a block, of a video or frame. Rate-distortion optimization includes determining a respective cost, such as based on a combination of rate (R), or rate value, and distortion (D), or approximations thereof, for respective sets of one or more coding parameters and identifying, or selecting, the set of coding parameters corresponding to the minimal cost, among the sets of coding parameters, as the parameters for codding the current portion, such as the current block, of the video or frame.

For example, in a block-based mode decision, the encoder identifies, as the encoding mode for a current block, a candidate mode that has a minimal rate-distortion cost, or rate-distortion optimization cost value, (J) among the rate-distortion costs for the candidate modes. For a respective candidate mode, the encoder obtains, such as by calculating or otherwise accessing, a value of a rate metric (Rₙ) corresponding to encoding the current block using the candidate mode. The encoder obtains a value of a distortion metric (Dₙ) representing, or measuring, differences between a source image (Sₙ), or a portion thereof corresponding to the current block, and a candidate reconstructed image (Ŝₙ), or a portion thereof corresponding to the current block. In some implementations, the distortion may be determined as the squared (l₂) error (Dₙ=∥Sₙ−Ŝₙ∥²) between the source image (Sₙ) and the reconstructed image (Ŝₙ). Other distortion metrics may be used. In some implementations, a rate-distortion cost, or rate-distortion cost value, (J) may be obtained for a candidate reconstructed block (x) using a rate-distortion optimization cost function that obtains, such as calculates, a sum of the value of the distortion metric (D(x)) and a result of multiplying the value of the rate metric (R) by a Lagrangian multiplier (λ), which may be expressed as the following:

$$J = D ( x ) + λ R . \qquad [ Equation 1 ]$$

The input video data is obtained (at 710). The input video data includes a sequence of frames (input frames). For example, the encoder, or a component thereof, such as an intra/inter prediction unit of the encoder, such as the intra/inter prediction unit 410 shown in FIG. 4, may obtain the input video stream.

The current frame for encoding is obtained (at 720) from the sequence of frames from the input video data. The current frame may be obtained (at 720) subsequent to encoding one or more other frames, such as a frame sequentially preceding the current frame in the input video stream, and generating, or otherwise obtaining, a corresponding reconstructed frame (or frames), or one or more portions thereof, for use as a reference frame (or frames) for encoding the current frame.

A gradient map for the current frame is obtained (at 730). The gradient map is obtained from an artificial intelligence, or machine learning, image, or video, quality model. The machine learning video quality model is a trained machine learning video quality model, such as a machine learning video quality model trained using training data including labeled images, videos, or both. The machine learning video quality model is a non-reference, or non-reference based, model, wherein “non-reference” indicates that the gradient map is obtained from the machine learning video quality model using a first image or frame, such as the current input image or a current reconstructed image, as input and in the absence of using, or referencing, a second image, such as the current reconstructed image or the current input image. In some implementations, the machine learning video quality model is a neural-network-based video quality model.

To obtain the gradient map, or neural-network-based video quality model generated gradient map, for the current frame the encoder, or a component thereof, sends, transmits, or otherwise makes available, the current frame (input frame) to the video quality model, or an instanced thereof, as input data. The encoder, or a component thereof, receives, reads, obtains, or otherwise accesses, the gradient map from the video quality model, such as in response to sending, transmitting, or otherwise making available, the current (input) image to the video quality model.

Encoding using media compression and processing for machine-learning-based quality metrics 700 includes using data, such as a gradient map, obtained from an artificial intelligence, or machine learning, model, such as a neural-network model, such as a universal video quality (UVQ) model, which is a neural-network-based video quality model, for encoder optimization and enhancement. The machine-learning-based video quality model generated gradient map indicates the effect of distortion for an area, such as a block, or a pixel relative to the reconstructed image quality for the image or frame. Although described with respect to the universal video quality model, other artificial intelligence, or machine learning, quality models may be used. In some implementations, obtaining the machine-learning-based video quality model generated gradient map includes obtaining a corresponding universal video quality model score for the current input frame.

In some implementations, the machine-learning-based video quality model generated gradient map is pixel-based, such as including a, such as one, gradient value, per-pixel for a respective frame. In some implementations, the machine-learning-based video quality model generated gradient map is block-based, such as including one gradient value per block, such as per 16×16 pixel block, for a respective frame. A gradient value, or the magnitude thereof, for a pixel, or a block, represents, or approximates, the extent to which a quality score for the frame is affected by a change, which may be a small change, of the pixel value, or of the block.

The current block for encoding is obtained (at 740) from the current frame (obtained at 720). The current block may be obtained (at 740) subsequent to encoding one or more other blocks, such as a block sequentially preceding the current block in the current frame, in accordance with a block coding order for coding the current frame, and generating, or otherwise obtaining, a corresponding reconstructed block, or one or more portions thereof.

Rate-distortion optimization is performed (at 750) for encoding the current block (obtained at 740).

Rate-distortion optimization (at 750) includes identifying, or selecting, encoding parameters, or a set thereof, for encoding the current block from among multiple available parameters, or sets thereof.

Rate-distortion optimization (at 750) includes, for a respective set of current candidate encoding parameters from among multiple available parameters, or sets thereof, such as a current candidate encoding mode, obtaining a current candidate encoded block by encoding the current block (current input block) using the current candidate set of encoding parameters, obtaining a current candidate reconstructed block by decoding and reconstructing the current candidate encoded block, and obtaining a rate-distortion cost, or score, for encoding the current block using the current candidate set of encoding parameters. The rate-distortion cost, value, or score, for encoding the current block using a respective candidate set of encoding parameters is obtained using a rate-distortion optimization cost function. The candidate encoding parameters corresponding to the minimal cost, or score, are identified as the coding parameters for the current block.

The rate-distortion optimization cost function (J) shown in Equation 1 may be weakly, or poorly, correlated with human perception, such that rate-distortion optimization using the rate-distortion optimization cost function (J) shown in Equation 1 may be sub-optimal.

To improve the optimization of rate-distortion optimization, relative to rate-distortion optimization using the rate-distortion optimization cost function (J) shown in Equation 1, the rate-distortion optimization (at 750) described herein includes using a machine-learning-based video quality optimized rate-distortion optimization cost function (J′) that incorporates data from the machine-learning-based video quality model generated gradient map (obtained at 730), such as the per-block gradient value, or the per-pixel gradient values, obtained from the machine-learning-based video quality model generated gradient map (obtained at 730) spatially corresponding to the current block.

The distortion of the current candidate reconstructed block (D(x)) is approximately equivalent (˜) to a sum of the distortion of the current block (D(x₀)) and a dot product (·) of a result of a gradient function (G(·)) with respect to the current block (x₀), which is a gradient value from the gradient map, and a difference between the current candidate reconstructed block (x) and the current block (x₀), obtained by subtracting the current block (x₀) from the current candidate reconstructed block (x), which may be expressed as the following:

$$D ( x ) ∼ D ( {x}_{0} ) + G ( {x}_{0} ) \cdot ( x - {x}_{0} ) .$$

The machine-learning-based video quality optimized rate-distortion optimization cost function (J′) that incorporates data from the machine-learning-based video quality model generated gradient map (obtained at 730), which includes regularizing (x−x₀), wherein the gradient (G(x₀)) is accurate around the current input block (x₀), includes obtaining a sum of a dot product (·) of a result of the gradient value from the gradient map for the current block (G(x₀)), which is a block size vector, and the current candidate reconstructed block (x) and a product of multiplying the value of the rate metric (R) for encoding the current block using the current candidate coding parameters by a Lagrangian multiplier (λ), which may be expressed as the following:

$${J}^{′} = G ( {x}_{0} ) \cdot x + λ R . \qquad [ Equation 2 ]$$

In some implementations, to reduce computational complexity, relative to using the machine-learning-based video quality optimized rate-distortion optimization cost function shown in Equation 2, a mean square error (MSE) based quality relationship may be used. To obtain, or derive, a mean squared error to quality relationship, the encoder aggregates the machine-learning-based video quality model generated gradient map (G(x)) into a block-based gradient map that associates the quality metric effect with the distortion of a block. For example, a sum of squared gradients, or gradient values, of a block may be obtained to represent an importance of the block (G_{b}). The encoder performs rate distortion optimization to approximately minimize the machine-learning-based video quality optimized rate-distortion optimization cost function (J′) shown in Equation 3, using the mean squared error to quality relationship, such as by obtaining a sum of a product of multiplying a sum of squared gradients of the current candidate reconstructed block by a mean squared error between the current block and the current candidate reconstructed block and a product a product of multiplying the value of the rate metric (R) for encoding the current block using the current candidate coding parameters by a Lagrangian multiplier (λ), which may be expressed as the following:

$${J}^{′} = {G}_{b} ( x ) * MSE + λ R . \qquad [ Equation 3 ]$$

The approximation indicated in Equation 3 uses the Cauchy-Schwarz inequality, which may be expressed as the following:

$${{‖ \cdot ( G ( {x}_{0} ) , ( x - {x}_{0} ) ) ‖}^{2} \leq {‖ G ( {x}_{0} ) ‖}^{2} ‖ x - {x}_{0} ) ‖}^{2} = {G}_{b} ( {x}_{0} ) * MSE .$$

The rate-distortion optimization (at 750) includes identifying, or selecting, encoding parameters, or a set thereof, for encoding the current block from among multiple available parameters, or sets thereof, using the machine-learning-based video quality optimized rate-distortion optimization cost function (J′) shown in Equation 2 or Equation 3.

A current encoded block (current encoded block data) is obtained (at 760) in accordance with, or using, the encoding parameters obtained by rate-distortion optimization (at 750).

The current encoded block data is included in encoded frame data for the current frame (at 770).

The encoded frame data for the current frame is included in an encoded, or output, bitstream. The output, compressed, or encoded, bitstream, is output, such as stored or transmitted, such as to a decoder, (at 780).

In some implementations, the encoded frame is decoded, and a corresponding reconstructed frame is obtained, or generated, such as for use as a reference frame for encoding another frame, such as shown in FIG. 4 (at 450-480). In some implementations, obtaining the reconstructed frame includes restoration filtering (at 790), such as in-loop restoration filtering, to obtain a restoration filtered reconstructed frame, wherein the restoration filtered reconstructed frame has improved image quality relative to the reconstructed frame. Restoration filtering (at 790) is shown with a broken line border to indicate that restoration filtering (at 790) may be omitted, skipped, or excluded.

Although not shown separately in FIG. 7, restoration filtering (at 790) includes obtaining a second machine-learning-based video quality model generated gradient map based on the reconstructed frame. To obtain the second machine-learning-based video quality model generated gradient map for the reconstructed frame the encoder, or a component thereof, sends, transmits, or otherwise makes available, the reconstructed frame to the machine-learning-based video quality model, or an instanced thereof, as input data, wherein the machine-learning-based video quality model is a machine learning non-reference-based media quality model. The encoder, or a component thereof, receives, reads, obtains, or otherwise accesses, the second machine-learning-based video quality model generated gradient map for the reconstructed frame from the machine-learning-based video quality model, such as in response to sending, transmitting, or otherwise making available, the reconstructed frame to the machine-learning-based video quality model.

A gradient value from the second machine-learning-based video quality model generated gradient map corresponding to a current reconstructed block (x₀) of the reconstructed frame (G(x₀)) represents a quality metric change with a relatively small amount of disturbance. To improve the quality of the reconstructed frame, the current reconstructed block of the reconstructed frame may be replaced with a restoration filtered reconstructed block (x), such as a result of dividing a product of multiplying a learning rate (α) by a gradient value (G(x₀)) from the gradient map for the current reconstructed block by a Euclidean norm of the gradient value (∥G(x₀)∥₂), which may be expressed as (x=x₀+dx), wherein dx=αG(x₀)/∥G(x₀)/∥₂. The restoration filter (at 790) may be applied on a per-block basis.

In some implementations, the encoder may include, in the encoded bitstream, one or more bits, symbols, flags, or other bitstream elements, to indicate whether in-loop restoration filtering using the machine-learning-based video quality model generated gradient map based on the reconstructed frame is used, such as on a per-frame or a per-block basis.

Although described with respect to video coding, media compression and processing for machine-learning-based quality metrics 700 may be used to optimize other media compression and restoration, such as image compression, audio compression, or speech compression.

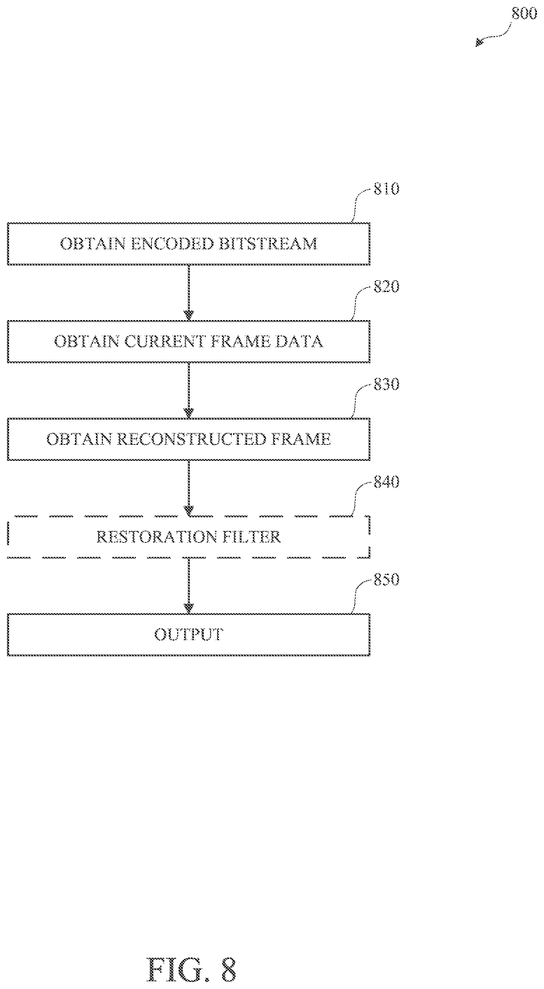

FIG. 8 is a flow diagram of an example of decoding using media compression and processing for machine-learning-based quality metrics 800. Decoding using media compression and processing for machine-learning-based quality metrics 800 may be implemented by a decoder, such as the decoder 500 shown in FIG. 5. For example, decoding using media compression and processing for machine-learning-based quality metrics 800 may include block-based hybrid video coding as described herein. One or more aspects of decoding using media compression and processing for machine-learning-based quality metrics 800 may be omitted from the description herein for simplicity and brevity.

Decoding using media compression and processing for machine-learning-based quality metrics 800 includes generating reconstructed video data by decoding an encoded bitstream, such as the encoded bitstream output as shown (at 780) in FIG. 7, or one or more portions thereof, to generate a reconstructed video, or a portion thereof, such as the output video stream 504 shown in FIG. 5.

Decoding using media compression and processing for machine-learning-based quality metrics 800 includes obtaining an encoded bitstream (at 810), obtaining current frame data (at 820), obtaining a reconstructed frame (at 830), restoration filtering (at 840), and outputting the reconstructed frame (at 850). Decoding using media compression and processing for machine-learning-based quality metrics 800 may include other aspects of decoding, reconstruction, or both, not expressly shown in FIG. 8.

The encoded bitstream is obtained (at 810). For example, the decoder, or a component thereof, such as an intra/inter prediction unit of the decoder, such as the entropy decoding unit 510 shown in FIG. 5, receives, reads, obtains, or otherwise accesses, an encoded bitstream (at 810), or one or more portions thereof, such as the encoded bitstream output as shown (at 780) in FIG. 7, the compressed bitstream 502 shown in FIG. 5 or the compressed bitstream 404 shown in FIG. 4. Obtaining the encoded bitstream includes identifying a current frame from a current sequence of frames to decode from the encoded bitstream to generate a current reconstructed frame. Obtaining the encoded bitstream includes identifying a current block of a current frame to decode from the encoded bitstream to generate a current reconstructed block for a current reconstructed frame.

The decoder, or a component thereof, extracts, reads, decodes, or otherwise accesses, (at 820) from the encoded bitstream (obtained at 810), encoded frame data for decoding the current frame (current frame data). Obtaining the encoded frame data (at 820) may include entropy decoding, such as the entropy decoding shown at 510 in FIG. 5.

The decoder, or a component thereof, obtains a reconstructed frame (at 830) (current reconstructed frame or current reconstructed frame data) by decoding the encoded frame data (obtained at 820). Obtaining the reconstructed frame (at 830) may include dequantization, such as the dequantization shown at 520 in FIG. 5, inverse transformation, such as the inverse transformation shown at 530 in FIG. 5, prediction, such as the prediction shown at 540 in FIG. 5, reconstruction, such as the reconstruction shown at 550 in FIG. 5, filtering, such as the filtering shown at 560 in FIG. 5, or a combination thereof.

The decoder, or a component thereof, obtains a restoration filtered reconstructed frame (at 840). Obtaining the restoration filtered reconstructed frame includes restoration filtering the reconstructed frame, which may be similar to restoration filtering as shown (at 790) in FIG. 7, except as is described herein or as is otherwise clear from context. Restoration filtering (at 840) is shown with a broken line border to indicate that restoration filtering (at 840) may be omitted, skipped, or excluded.

In some implementations, the encoder performs in-loop restoration filtering as shown (at 790) in FIG. 7, and the restoration filtering shown (at 840) in FIG. 8 is in-loop restoration filtering. In some implementations, the decoder may decode, or other obtain, one or more bits, symbols, flags, or other bitstream elements, from the encoded bitstream indicating whether in-loop restoration filtering using the machine-learning-based video quality model generated gradient map based on the reconstructed frame is used, such as is enable or is unavailable, such as on a per-frame or a per-block basis, and may perform, or omit performing, in-loop restoration filtering in accordance with the decoded bitstream data.

In some implementations, the encoder omits, skips, avoids, or excludes in-loop restoration filtering, and the restoration filtering shown (at 840) in FIG. 8 is performed subsequent to storing the reconstructed frame (obtained at 840) for use as a reference frame for decoding another frame.

The decoder, or a component thereof, outputs (at 850) the reconstructed frame (obtained at 840), or the restoration filtered reconstructed frame (obtained at 840), such as for storage or presentation. The reconstructed frame output (at 850) may be similar to the output video stream 504, or a portion thereof, shown in FIG. 5.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available. It will be appreciated that aspects can be implemented in any convenient form. For example, aspects may be implemented by appropriate computer programs which may be carried on appropriate carrier media which may be tangible carrier media (e.g., disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method comprising:
generating encoded frame data by encoding a current frame from an input video, wherein encoding the current frame includes using a neural-network-based video quality model; and
outputting the encoded frame data.

2. The method of claim 1, wherein encoding the current frame using the neural-network-based video quality model includes:
obtaining a neural-network-based video quality model generated gradient map generated for the current frame by the neural-network-based video quality model;
obtaining a current block from the current frame;
identifying optimal encoding parameters for encoding the current block from a plurality of available encoding parameters, wherein the optimal encoding parameters minimizes a rate-distortion optimization cost function relative to the plurality of available encoding parameters, wherein minimizing the rate-distortion optimization cost function includes using a gradient value for the current block obtained from the neural-network-based video quality model generated gradient map;
obtaining encoded block data by encoding the current block using the optimal encoding parameters; and
including the encoded block data in the encoded frame data.

3. The method of claim 2, wherein obtaining the neural-network-based video quality model generated gradient map includes:
using the current frame as input to the neural-network-based video quality model; and
receiving the neural-network-based video quality model generated gradient map from the neural-network-based video quality model.

4. The method of claim 3, wherein obtaining the neural-network-based video quality model generated gradient map includes:
omitting using a frame other than the current frame as input to the neural-network-based video quality model

5. The method of claim 2, wherein identifying the optimal encoding parameters includes:
obtaining a rate-distortion optimization cost value for the optimal encoding parameters using the rate-distortion optimization cost function as a sum of:
a dot product of:
a gradient value from the gradient map for the current block; and
a reconstructed block obtained by encoding the current block using the optimal encoding parameters; and
a product of multiplying a rate value for encoding the current block using the optimal encoding parameters by a Lagrangian multiplier.

6. The method of claim 2, wherein identifying the optimal encoding parameters includes:
obtaining a rate-distortion optimization cost value for the optimal encoding parameters using the rate-distortion optimization cost function as a sum of:
a product of multiplying:
a sum of squared gradient values from the gradient map for the current block; by
a mean squared error between the current block and a reconstructed block obtained by encoding the current block using the optimal encoding parameters; and
a product of multiplying a rate value for encoding the current block using the optimal encoding parameters by a Lagrangian multiplier.

7. The method of claim 2, further comprising:
obtaining a reconstructed frame by decoding the encoded frame data;
obtaining a second neural-network-based video quality model generated gradient map generated for the reconstructed frame from the neural-network-based video quality model;
obtaining a restoration filtered reconstructed frame by restoration filtering the reconstructed frame using the second neural-network-based video quality model generated gradient map; and
storing the restoration filtered reconstructed frame for use as a reference frame for encoding another frame.

8. The method of claim 1, wherein encoding the current frame includes:
obtaining a reconstructed frame by decoding the encoded frame data;
obtaining a neural-network-based video quality model generated gradient map generated for the reconstructed frame from the neural-network-based video quality model;
obtaining a restoration filtered reconstructed frame by restoration filtering the reconstructed frame using the neural-network-based video quality model generated gradient map; and
storing the restoration filtered reconstructed frame for use as a reference frame for encoding another frame.

9. An apparatus comprising:
a non-transitory computer readable medium; and
a processor configured to execute instructions stored on the non-transitory computer readable medium to:
generate encoded frame data, wherein, to generate the encoded frame data the processor executes the instructions to encode a current frame from an input video, wherein to encode the current frame the processor executes the instructions to use a neural-network-based video quality model; and
output the encoded frame data.

10. The apparatus of claim 9, wherein to use the neural-network-based video quality model the processor executes the instructions to:
obtain a neural-network-based video quality model generated gradient map generated for the current frame by the neural-network-based video quality model;
obtain a current block from the current frame;
identify optimal encoding parameters for encoding the current block from a plurality of available encoding parameters, wherein the optimal encoding parameters minimizes a rate-distortion optimization cost function relative to the plurality of available encoding parameters, wherein to maximize the rate-distortion optimization cost function the processor executes the instructions to use a gradient value for the current block obtained from the neural-network-based video quality model generated gradient map;
obtain encoded block data, wherein, to obtain the encoded block data the processor executes the instructions to encode the current block using the optimal encoding parameters; and
include the encoded block data in the encoded frame data.

11. The apparatus of claim 10, wherein to obtain the neural-network-based video quality model generated gradient map the processor executes the instructions to:
use the current frame as input to the neural-network-based video quality model; and
receive the neural-network-based video quality model generated gradient map from the neural-network-based video quality model.

12. The apparatus of claim 11, wherein to obtain the neural-network-based video quality model generated gradient map the processor executes the instructions to:
omit using a frame other than the current frame as input to the neural-network-based video quality model.

13. The apparatus of claim 10, wherein to identify the optimal encoding parameters the processor executes the instructions to:
obtain a rate-distortion optimization cost value for the optimal encoding parameters using the rate-distortion optimization cost function as a sum of:
a dot product of:
a gradient value from the gradient map for the current block; and
a reconstructed block obtained by encoding the current block using the optimal encoding parameters; and
a product of multiplication of a rate value for encoding the current block using the optimal encoding parameters by a Lagrangian multiplier.

14. The apparatus of claim 10, wherein to identify the optimal encoding parameters the processor executes the instructions to:
obtain a rate-distortion optimization cost value for the optimal encoding parameters in accordance with the rate-distortion optimization cost function as a sum of:
a product of a multiplication of:
a sum of squared gradient values from the gradient map for the current block; by
a mean squared error between the current block and a reconstructed block obtained by encoding the current block using the optimal encoding parameters; and
a product of a multiplication of a rate value for encoding the current block using the optimal encoding parameters by a Lagrangian multiplier.

15. The apparatus of claim 10, wherein the processor executes the instructions to:
obtain a reconstructed frame, wherein to obtain the reconstructed frame the processor executes the instructions to decode the encoded frame data;
obtain a second neural-network-based video quality model generated gradient map generated for the reconstructed frame from the neural-network-based video quality model;
obtain a restoration filtered reconstructed frame, wherein, to obtain the restoration filtered reconstructed frame the processor executes the instructions to restoration filter the reconstructed frame using the second neural-network-based video quality model generated gradient map; and
store the restoration filtered reconstructed frame for use as a reference frame for encoding another frame.

16. The apparatus of claim 9, wherein to encoding the current frame the processor executes the instructions to:
obtain a reconstructed frame, wherein, to obtain the reconstructed frame the processor executes the instructions to decode the encoded frame data;
obtain a neural-network-based video quality model generated gradient map generated for the reconstructed frame from the neural-network-based video quality model;
obtain a restoration filtered reconstructed frame, wherein, to obtain the restoration filtered reconstructed frame the processor executes the instructions to restoration filter the reconstructed frame using the neural-network-based video quality model generated gradient map; and
store the restoration filtered reconstructed frame for use as a reference frame for encoding another frame.

17. A method comprising:
obtaining an encoded bitstream;
obtaining encoded frame data from the encoded bitstream;
obtaining a reconstructed frame by decoding the encoded frame data;
obtaining restoration filtered reconstructed frame data by:
obtaining, from a neural-network-based video quality model, a neural-network-based video quality model generated gradient map generated for the reconstructed frame; and
generating restoration filtered reconstructed frame data by restoration filtering the reconstructed frame using the neural-network-based video quality model generated gradient map; and
storing the restoration filtered reconstructed frame for use as a reference frame for encoding another frame.

18. The method of claim 17, wherein:
in response to determining that in-loop restoration filtering using the neural-network-based video quality model generated gradient map is enabled, storing the restoration filtered reconstructed frame includes including the restoration filtered reconstructed frame in an output video stream.

19. The method of claim 17, wherein:
in response to determining that in-loop restoration filtering using the neural-network-based video quality model generated gradient map is unavailable, obtaining the reconstructed frame includes including the reconstructed frame in an output video stream.

20. The method of claim 17, wherein restoration filtering the reconstructed frame using the neural-network-based video quality model generated gradient map includes:
obtaining a current reconstructed block from the reconstructed frame;
obtaining a restoration filtered reconstructed block as a sum of:
the current reconstructed block; and
a result of:
dividing:
a product of multiplying a learning rate by a gradient value from the gradient map for the current reconstructed block; by
a Euclidean norm of the gradient value.
